(19) United States
(12) Patent Application Publication
(10) Pub. No.: US 2013/0153690 A1
(43) Pub. Date: Jun. 20, 2013

(54) ELECTROSTATIC ATOMIZATION DEVICE

(71) Applicants: Takafumi Omori, Shiga (JP); Takayuki Nakada, Shiga (JP); Yusuke Yamada, Shiga (JP)

(72) Inventors: Takafumi Omori, Shiga (JP); Takayuki Nakada, Shiga (JP); Yusuke Yamada, Shiga (JP)

(73) Assignee: PANASONIC CORPORATION, Osaka (JP)

(21) Appl. No.: 13/819,204

(22) PCT Filed: Aug. 31, 2011
(86) PCT No.: PCT/JP2011/069748

§ 371 Date: Feb. 26, 2013

(30) Foreign Application Priority Data
Sep. 27, 2010 (JP) 2010-215172

(51) Int. Cl. B05B 5/00

(52) U.S. Cl. CPC B05B 5/00
USPC 239/690

(57) ABSTRACT

An electrostatic atomization device comprises: an electric discharge electrode having a front end section and a base end section; a cooling section for cooling the electric discharge electrode; a high-voltage application section for generating electrically charged water particles by atomizing condensed water, which is held by the electric discharge electrode, by causing the front end section of the electric discharge electrode to discharge electricity; and a heat capacity adjustment member provided to the vicinity of the base end section of the electric discharge electrode and capable of heat transfer with the electric discharge electrode through the condensed water held by the electric discharge electrode.

### TECHNICAL FIELD

The present invention relates to an electrostatic atomization device that atomizes condensed water formed on a surface of a discharge electrode to generate charged fine water particles.

### BACKGROUND ART

An electrostatic atomization device that includes a cooling unit to cool a discharge electrode and provide the discharge electrode with water is known in the prior art (refer to patent document 1 and patent document 2). The electrostatic atomization device cools the discharge electrode with the cooling unit and forms condensed water on the surface of the discharge electrode. The electrostatic atomization device applies high voltage to the discharge electrode to cause discharging that atomizes the condensed water held on a distal portion of the discharge electrode and generate charged fine water particles, which are mildly acidic and include electric charges. The charged fine water particles moisturize skin and hair and deodorize air and articles. Thus, many effects may be obtained by using the electrostatic atomization device in various products.

In each of the electrostatic atomization devices described in patent document 1 and patent document 2, the cooling unit includes a plurality of thermoelectric elements. The thermoelectric elements are held between two circuit boards. The two circuit boards are obtained by forming circuits on one surface of each of opposing insulative plates. In the two circuit boards, the circuits electrically connect adjacent thermoelectric elements. The first circuit board, which functions as a heat absorption side, is connected by a cooling insulative plate to the discharge electrode. The second circuit board, which functions as a heat radiation side, is connected to a heat radiation plate. In the electrostatic atomization device, when the thermoelectric elements are energized, heat absorption sides of the thermoelectric elements cool the discharge electrodes through the circuit board, insulative plate, and cooling insulative plate. The cooling forms condensed water on the surface of the discharge electrode.

### PRIOR ART DOCUMENTS

### Patent Documents

Patent Document 1: Japanese Laid-Open Patent Publication No. 2006-826

Patent Document 2: Japanese Laid-Open Patent Publication No. 2006-61072 (FIG. 4)

### SUMMARY OF THE INVENTION

### Problems that are to be Solved by the Invention

In the electrostatic atomization devices described in patent document 1 and patent document 2, excessive condensed water may form on the surface of the discharge electrode depending on the cooling state of the discharge electrode. When a large amount of excessively formed condensed water collects at the base of the discharge electrode, the discharging at the distal portion of the discharge electrode may become unstable. To suppress collection of excessively generated condensed water at the base of the discharge electrode, an atomization device may include a control circuit that adjusts the cooling performance of the cooling unit. However, the use of such a control circuit to control the cooling unit increases the costs of the electrostatic atomization device.

Accordingly, it is an object of the present invention to provide an electrostatic atomization device that allows the cooling state of the discharge electrode to be adjusted without controlling the cooling unit.

### Means for Solving the Problem

To solve the above problem, an electrostatic atomization device is provided with a discharge electrode including a distal portion and a basal portion. A cooling unit cools the discharge electrode. A high-voltage application unit causes discharging at the distal portion of the discharge electrode to atomize condensed water held on the discharge electrode and generate charged fine water particles. The heat capacity adjustment member is arranged proximal to the basal portion of the discharge electrode. The heat capacity adjustment member is capable of heat transfer with the discharge electrode through the condensed water held on the discharge electrode.

Preferably, in the electrostatic atomization device, the heat capacity adjustment member is arranged so that the condensed water collects between the heat capacity adjustment member and the basal portion of the discharge electrode.

Preferably, in the electrostatic atomization device, the heat capacity adjustment member is arranged around the cooling unit.

Preferably, the electrostatic atomization device further includes a heat radiation energizing member that supports the cooling unit. The heat radiation energizing member is electrically conductive and thermally conductive. The heat capacity adjustment member is arranged opposing the heat radiation energizing member to form a gap capable of holding the condensed water between the heat capacity adjustment member and the heat radiation energizing member.

Preferably, in the electrostatic atomization device, the heat capacity adjustment member has a water absorption property.

Preferably, in the electrostatic atomization device, the heat capacity adjustment member is formed from a porous material.

Preferably, in the electrostatic atomization device, the porous material is a ceramic or pumice stone.

Preferably, in the electrostatic atomization device, the cooling unit includes a thermoelectric element that cools the discharge electrode when supplied with power.

### Effect of the Invention

The present invention provides an electrostatic atomization device that allows the cooling state of the discharge electrode to be adjusted without controlling the cooling unit.

### BRIEF DESCRIPTION OF THE DRAWINGS

FIGS. 1(a) and 1(b) are schematic diagrams showing a first embodiment of an electrostatic atomization device; and

FIGS. 2(a) and 2(b) are schematic diagrams showing a second embodiment of an electrostatic atomization device.

### EMBODIMENTS OF THE INVENTION

### First Embodiment

A first embodiment of an electrostatic atomization device according to the present invention will now be described with reference to the drawings.

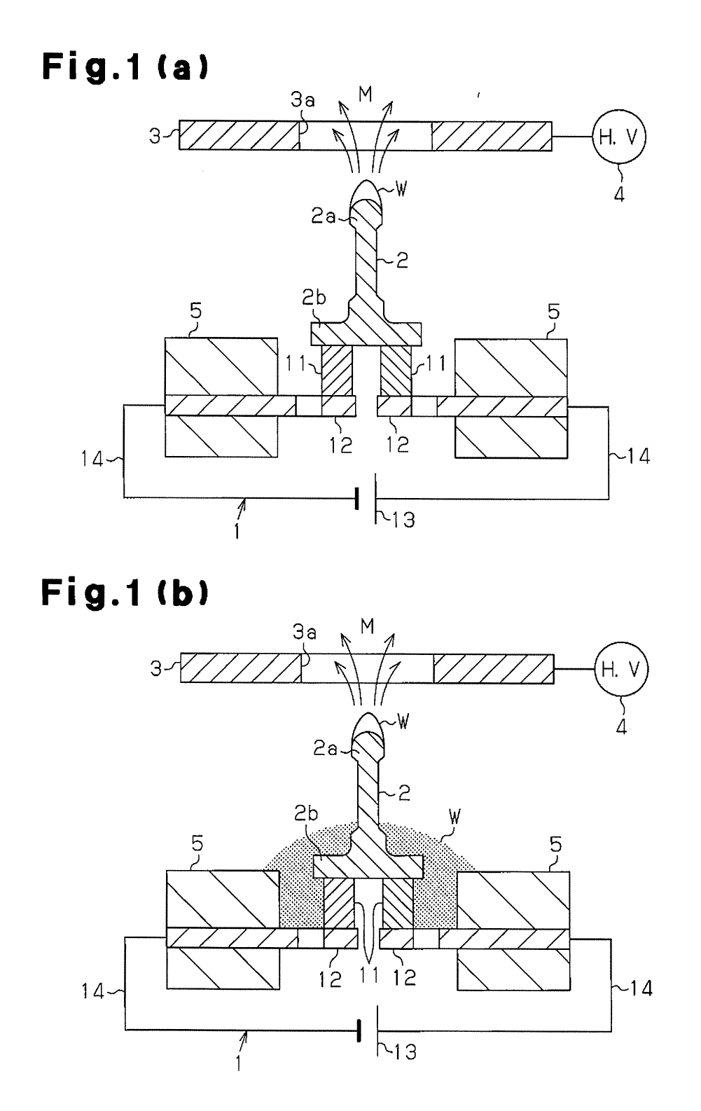

FIG. 1(a) is a schematic diagram showing the electrostatic atomization device of the first embodiment. As shown in FIG. 1(a), the electrostatic atomization device includes a cooling unit 1, a discharge electrode 2, an opposing electrode 3, a high-voltage application unit 4, and a heat capacity adjustment member 5.

The cooling unit 1 includes two thermoelectric elements 11, which are BiTe Peltier elements. One thermoelectric element 11 is a P-type Peltier element, and the other thermoelectric element is an N-type Peltier element. The thermoelectric elements 11 include heat radiation sides (lower sides as viewed in FIG. 1(a)) directly coupled, mechanically and electrically, to heat radiation energizing members 12, respectively. Each heat radiation energizing member 12 is made of an electrically conductive and thermally conductive material (e.g., brass, aluminum, and copper). The heat radiation energizing members 12, which are connected to the thermoelectric elements 11, are electrically connected to each other by a lead line 14 via a voltage application unit 13, which is formed by a DC power supply.

The discharge electrode 2 is generally cylindrical and made of a thermally conductive and electrically conductive material (e.g., aluminum, copper, tungsten, titanium, and stainless). The discharge electrode 2 includes a distal portion, or spherical discharge portion 2a, and a basal portion, or base 2b, which is flange-shaped and extends outward in the radial direction. Further, the discharge electrode 2 includes a basal end surface, that is, the end surface of the base 2b opposite to the discharge portion 2a in the axial direction. The basal end surface is mechanically and electrically connected to heat absorption sides of the two thermoelectric elements 11. Accordingly, the discharge electrode 2 electrically connects the two thermoelectric elements 11. In the cooling unit 1, the voltage application unit 13 energizes the two thermoelectric elements 11, the heat radiation energizing members 12, and the discharge electrode 2 through the lead line 14. Consequently, the thermoelectric elements 11 function to transfer heat from the discharge electrode 2, which is at the heat absorption side, to the heat radiation energizing member 12, which is at the heat radiation side. As a result, the thermoelectric elements 11 directly cool the discharge electrode 2 and form condensed water W on the surface of the discharge electrode 2.

The opposing electrode 3 is arranged at a position opposing the discharge portion 2a of the discharge electrode 2. A round outlet 3a extends through a central part of the opposing electrode 3. The high-voltage application unit 4 is connected to the opposing electrode 3.

The heat capacity adjustment member 5 is formed to allow heat transfer with the discharge electrode 2 through the condensed water W formed on the surface of the discharge electrode 2 in the proximity of the basal portion of the discharge electrode 2. In the present embodiment, the heat capacity adjustment member 5 is formed around the base 2b of the discharge electrode 2. Further, the heat capacity adjustment member 5 is formed integrally with the heat radiation energizing members 12 to embed the heat radiation energizing members 12. The heat capacity adjustment member 5 is made of an electrically insulative resin material.

In the electrostatic atomization device, which is formed as described above, when the cooling unit 1 cools the discharge electrode 2, the air surrounding the discharge electrode 2 is cooled, and the moisture in the air condenses and forms condensed water W on the surface of the discharge electrode 2. Then, in a state in which condensed water W is held on the discharge electrode 2, particularly, the discharge portion 2a, the high-voltage application unit 4 applies high voltage to between the discharge electrode 2 and the opposing electrode 3 so that the discharge electrode 2 becomes a negative electrode where charges are concentrated. As a result, the discharge portion 2a, which is the distal portion of the discharge electrode 2, undergoes discharging. This causes electrostatic atomization that generates a vast amount of charged fine water particles M. The generated fine water particles M are attracted toward the opposing electrode 3 and discharged out of the electrostatic atomization device through the outlet 3a of the opposing electrode 3.

When the cooling unit 1 overcools the discharge electrode 2, excessive condensed water W is formed on the surface of the discharge electrode 2. Referring to FIG. 1(b), the excessive condensed water W moves along the surface of the discharge electrode 2 and collects in the proximity of the basal portion of the discharge electrode 2. When further excessive condensed water W is formed, the excessive condensed water W comes into contact with the heat capacity adjustment member 5. This allows for heat transfer between the discharge electrode 2 and the heat capacity adjustment member 5 through the excessive condensed water W. When heat can be transferred between the discharge electrode 2 and the heat capacity adjustment member 5 through the excessive condensed water W, the cooling unit 1 cools the discharge electrode 2, the heat capacity adjustment member 5, and the excessive water W between the discharge electrode 2 and the heat capacity adjustment member 5. Accordingly, as long as the power supplied to the thermoelectric elements 11 is constant, that is, as long as the cooling capacity of the cooling unit 1 is constant, the cooling of the discharge electrode 2 is impeded. This raises the temperature of the discharge electrode 2 and thereby suppresses the formation of excessive condensed water W on the surface of the discharge electrode 2.

As the excessive condensed water W collected at the basal portion of the discharge electrode 2 gradually decreases and no longer contacts the heat capacity adjustment member 5, the cooling unit 1 cools the discharge electrode 2 without cooling the heat capacity adjustment member 5. This enhances the formation of the condensed water.

As described above, the first embodiment has the advantages described below.

(1) When the discharge electrode 2 is overcooled and excessive condensed water W is formed, the excessively formed condensed water W allows for heat to be transferred between the basal portion of the discharge electrode 2 and the heat capacity adjustment member 5. Further, the excessive condensed water W transfers heat between the discharge electrode 2 and the heat capacity adjustment member 5. Thus, as long as the cooling capacity of the cooling unit 1 is constant, the cooling of the discharge electrode 2 is impeded. This suppresses excessive cooling of the discharge electrode 2. Thus, the cooling state of the discharge electrode 2 can be adjusted without controlling the cooling unit 1. Further, when the cooling of the discharge electrode 2 is impeded, the amount of the formed condensed water W decreases. This suppresses the formation of excessive condensed water W.

(2) The heat capacity adjustment member 5 adjusts the cooling state of the discharge electrode. Thus, even when the electrostatic atomization device cools the discharge electrode 2 with the thermoelectric elements 11, the cooling state of the discharge electrode 2 can be adjusted without controlling the power supplied to the thermoelectric elements 11.

(3) When the excessive condensed water W collected at the basal portion of the discharge electrode 2 allows for heat to be transferred between the discharge electrode 2 and the heat capacity adjustment member 5, overcooling of the discharge electrode 2 with the cooling unit 1 is suppressed. This suppresses freezing at the basal portion of the discharge electrode 2.

### Second Embodiment

A second embodiment according to the present invention will now be described with reference to the drawings. Here, same reference numerals are given to those components that are the same as the corresponding components of the first embodiment. Such components will not be described.

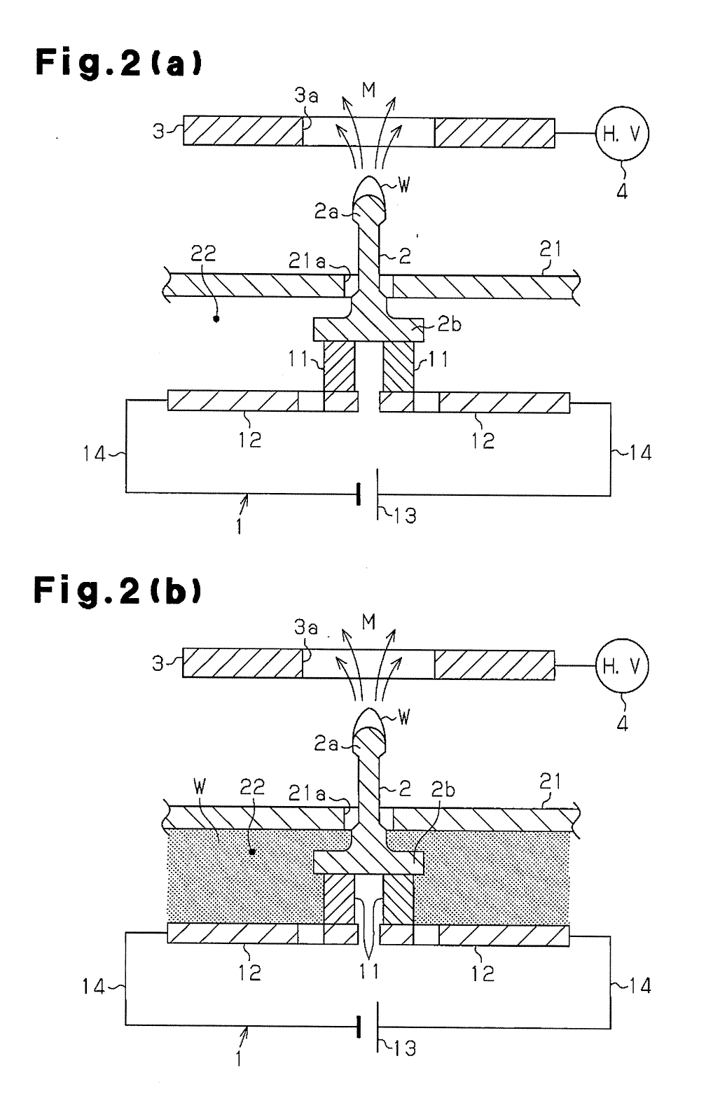

FIG. 2(a) is a schematic diagram showing an electrostatic atomization device of the second embodiment. The electrostatic atomization device of the second embodiment includes a heat capacity adjustment member 21 instead of the heat capacity adjustment member 5 (refer to FIG. 1(a)).

The heat capacity adjustment member 21 is formed from a ceramic, which is a porous material having a water absorption property. The heat capacity adjustment member 21 is formed to allow heat transfer with the discharge electrode 2 through the condensed water W formed on the surface of the discharge electrode 2 in the proximity of the basal portion of the discharge electrode 2. In detail, the heat capacity adjustment member 21 is plate-shaped and includes a through hole 21a, which extends through the heat capacity adjustment member 21 in the thicknesswise direction. The discharge electrode 2 is inserted through the through hole 21a, and the heat capacity adjustment member 21 is located toward the basal side of the discharge electrode 2 from the axially middle part of the discharge electrode 2 and is proximal to the base 2b in the axial direction (axial direction of the discharge electrode 2). The discharge electrode 2 and the heat capacity adjustment member 21 are not in contact with each other, and a slight gap is formed between the surface of the discharge electrode 2 and the wall of the through hole 21a. Further, the heat capacity adjustment member 21 is opposed to the heat radiation energizing members 12 in the axial direction of the discharge electrode 2, and a gap 22 is formed between the heat capacity adjustment member 21 and the heat radiation energizing members 12. Condensed water W can be held in the gap 22.

In the electrostatic atomization device of the second embodiment, when the cooling unit 1 overcools the discharge electrode 2, excessive condensed water W forms on the surface of the discharge electrode 2. Referring to FIG. 2(b), the excessive condensed water W flows along the surface of the discharge electrode 2 toward the basal portion of the discharge electrode 2 and then enters the gap 22 between the heat capacity adjustment member 21 and the heat radiation energizing members 12. Some of the condensed water W collected on the surface of the discharge electrode 2 is absorbed through the wall of the through hole 21a by the heat capacity adjustment member 21. When the gap 22 is filled with excessive condensed water W, some of the condensed water W comes into contact with and is absorbed by the heat capacity adjustment member 21. This allows for heat transfer between the discharge electrode 2 and the heat capacity adjustment member 21 through the excessive condensed water W. When the excessive condensed water W allows for heat transfer between the discharge electrode 2 and the heat capacity adjustment member 21, the cooling unit 1 cools the discharge electrode 2, the heat capacity adjustment member 21, and the excessive condensed water W between the discharge electrode 2 and the heat capacity adjustment member 21. Accordingly, as long as the power supplied to the thermoelectric elements 11 is constant, that is, as long as the cooling capacity of the cooling unit 1 is constant, the cooling of the discharge electrode 2 is impeded. This raises the temperature of the discharge electrode 2 and thereby suppresses the formation of excessive condensed water W on the surface of the discharge electrode 2.

Further, the heat capacity adjustment member 21 absorbs excessive condensed water W. This impedes the growth of a water pool caused by excessive condensed water W, such as a rise in the excessive condensed water W toward the distal side of the discharge electrode 2 from the heat capacity adjustment member 21. Accordingly, an increase in the amount of condensed water W that would result in instable discharging at the discharge portion 2a arranged at the distal portion of the discharge electrode 2 is suppressed.

As the excessive condensed water W collected at the basal portion of the discharge electrode 2 gradually decreases and no longer contacts the heat capacity adjustment member 21, the cooling unit 1 cools the discharge electrode 2 without cooling the heat capacity adjustment member 21. This enhances the formation of the condensed water.

As described above, in addition to advantages (1) and (2) of the first embodiment, the second embodiment has the advantages described below.

(4) The heat capacity adjustment member 21 has a water absorption property. Thus, the heat capacity adjustment member 21 can absorb excessive condensed water W collected at portions other than the distal portion of the discharge electrode 2 where discharging is performed during the formation of charged fine water particles M. This suppresses increases in the excessive condensed water W that causes instable discharging at the distal portion of the discharge electrode 2. Further, freezing at the basal portion of the discharge electrode 2 is suppressed.

(5) The heat capacity adjustment member 21 is formed by a porous material. Thus, the heat capacity adjustment member 21 is easily provided with the water absorption property.

(6) The porous material forming the heat capacity adjustment member 21 is a ceramic. This facilitates the formation of the porous heat capacity adjustment member 21.

The embodiments of the present invention may be modified as described below.

In each of the above embodiments, the cooling unit 1 includes only a pair of the thermoelectric elements 11. However, the cooling unit 1 may include plural pairs of the thermoelectric elements 11. Further, the thermoelectric elements 11 may be held between two circuit boards and be electrically connected to one another by the circuit boards. In this case, the discharge electrode 2 is arranged on the heat absorption side circuit board.

In each of the above embodiments, the cooling unit 1 is formed so that the thermoelectric elements 11 function to cool the discharge electrode. However, the cooling unit 1 is not limited to the structure of the above embodiments as long as it contacts the basal portion of the discharge electrode 2 and cools the discharge electrode 2. This would also obtain advantage (1) of the first embodiment.

In the second embodiment, the porous material forming the heat capacity adjustment member 21 is a ceramic but may be pumice stone instead. This would also facilitate the formation of the heat capacity adjustment member 21. Further, the heat capacity adjustment member 21 may be formed by a sponge having a water absorption property. The heat capacity adjustment member 21 may also be formed by a material that absorbs water other than a porous material.

As long as heat can be transferred with the discharge electrode 2 through the condensed water W formed on the surface of the discharge electrode 2 in the proximity of the basal portion of the discharge electrode 2, the heat capacity adjustment members 5 and 21 are not limited to the shapes and layout of the above embodiments.

In the above embodiment, the electrostatic atomization device applies high voltage to between the discharge electrode and the opposing electrode 3, which is arranged opposing the discharge portion 2a of the discharge electrode 2. However, the opposing electrode may be omitted from the electrostatic atomization device, and high voltage may be applied to the discharge electrode 2. Further, components of the electrostatic atomization device arranged around the discharge electrode, such as a charge elimination plate, may be used to function as the opposing electrode 3.

### Description of the Reference Numerals

1: Cooling Unit

2: Discharge Electrode

4: High-voltage Application Unit

5, 21: Heat Capacity Adjustment Member

11: Thermoelectric Element

12: Heat Radiation Energizing Member

22: Gap

M: Charged Fine Water Particles

W: Condensed Water

1. An electrostatic atomization device comprising:
a discharge electrode including a distal portion and a basal portion;
a cooling unit that cools the discharge electrode;
a high-voltage application unit that causes discharging at the distal portion of the discharge electrode to atomize condensed water held on the discharge electrode and generate charged fine water particles; and
a heat capacity adjustment member arranged proximal to the basal portion of the discharge electrode, wherein the heat capacity adjustment member is capable of heat transfer with the discharge electrode through the condensed water held on the discharge electrode.

2. The electrostatic atomization device according to claim 1, wherein the heat capacity adjustment member is arranged so that the condensed water collects between the heat capacity adjustment member and the basal portion of the discharge electrode.

3. The electrostatic atomization device according to claim 2, wherein the heat capacity adjustment member is arranged around the cooling unit.

4. The electrostatic atomization device according to claim 2, further comprising a heat radiation energizing member that supports the cooling unit, wherein the heat radiation energizing member is electrically conductive and thermally conductive, and
the heat capacity adjustment member is arranged opposing the heat radiation energizing member to form a gap capable of holding the condensed water between the heat capacity adjustment member and the heat radiation energizing member.

5. The electrostatic atomization device according to claim 1, wherein the heat capacity adjustment member has a water absorption property.

6. The electrostatic atomization device according to claim 5, wherein the heat capacity adjustment member is formed from a porous material.

7. The electrostatic atomization device according to claim 6, wherein the porous material is a ceramic or pumice stone.

8. The electrostatic atomization device according to claim 1, wherein the cooling unit includes a thermoelectric element that cools the discharge electrode when supplied with power.
